(19) United States
(12) Patent Application Publication
(10) Pub. No.: US 2013/0249467 A1
(43) Pub. Date: Sep. 26, 2013

(54) STUFFED ANIMAL CELL PHONE CHARGER

(71) Applicant: Manosh Varghese, Boca Raton, FL (US)

(72) Inventor: Manosh Varghese, Boca Raton, FL (US)

(21) Appl. No.: 13/849,965

(22) Filed: Mar. 25, 2013

Related U.S. Application Data
(60) Provisional application No. 61/614,948, filed on Mar. 23, 2012.

(51) Int. Cl. H02J 7/00

(52) U.S. Cl. CPC H02J 7/0044
USPC 320/103

(57) ABSTRACT

A stuffed animal cell phone charging device includes a cushioned main body having an internal rechargeable battery and a securing member for releasably holding a cell phone. The charging device may be adapted for wirelessly coupling with the cell phone for inductive charging or include at least one power plug adaptor for wired charging of the cell phone. An AC power plug in connection with the rechargeable battery recharges the rechargeable battery. The device includes speakers having wireless data exchange connectivity for wirelessly pairing with the cell phone to play music stored on a cell phone. Further embodiments of the charging device may include a pillow or other cushioned object. The device may include a handle or strap for carrying the device. The internal battery, speakers, power plug adaptors, audio connections and AC power plug may be removed so that the stuffed animal, or other cushioned object, may be washed.

This patent application is based on provisional patent application Ser. No. 61/614,948 filed on Mar. 23, 2012.

### BACKGROUND OF THE INVENTION

1. Field of the Invention

The present invention relates to cell phone charging devices and, more particularly, a stuffed animal cell phone charging device having a rechargeable internal battery that can be used to charge the battery of a cell phone.

2. Discussion of the Related Art

Cell phone users predominantly charge their cell phones using an AC wall charger in combination with an AC power outlet or a car charger adaptor in combination with an automobile power outlet. Both methods are limiting in that they require the cell phone to remain plugged in and within close proximity of either the AC power outlet or the automobile in order to be charged. Consequently, there are a number of problematic scenarios if a user's cell phone battery were to die while not having access to either an AC power outlet or an automobile, such as while on an airplane or a camping trip.

Furthermore, there are times when charging a cell phone using an AC power outlet, even when available, is not desirable. For example, it can be inconvenient to answer a call or browse the internet while in bed if the cell phone is hooked up to an AC outlet. Furthermore, a number of individuals leave their cell phone on their bed while it charges over night, which can be inconvenient due to the hard exterior of the cell phone case and accompanying cord in connection with the AC power outlet. The phone can also get lost in the sheets or fall under the bed.

Many people also use their phones to listen to music or watch movies. However, listening to music or watching videos can drain the battery quickly. Most portable docking stations that play music still require being plugged into a wall and any wireless ones would not be comfortable to have in bed.

Therefore, there exists a need for a portable cell phone charging device that includes a rechargeable internal battery, speakers, and cell phone connections, including power and audio connections, which is provided in the form of a stuffed animal, pillow or other cushioned object.

### OBJECTS AND ADVANTAGES OF THE PRESENT INVENTION

Considering the foregoing, it is a primary object of the present invention to provide a portable cell phone charging device having a rechargeable internal battery.

It is a further object of the present invention to provide a portable cell phone charging device in the form of a stuffed animal or other cushioned object.

It is a further object of the present invention to provide a portable cell phone charging device having multiple cell phone power plug adaptors for use with a variety of different cell phones, tablet PC's, or other electronic devices including mp3 players.

It is a further object of the present invention to provide a portable cell phone charging device having a pocket for releasably holding a cell phone to the charging device.

It is a further object of the present invention to provide a portable cell phone charging device having an audio plug in connection with speakers.

It is still a further object of the present invention to provide a portable cell phone charging device that supports the upper portion of a cell phone while connected to the charging device.

It is yet a further object of the present invention to provide a portable cell phone charging device that is machine washable.

These and other objects and advantages of the present invention are readily apparent with reference to the detailed description and accompanying drawings.

### SUMMARY OF THE INVENTION

The present invention is directed to a stuffed animal (or other shaped cushioned object) cell phone charging device including a cushioned body and having an internal rechargeable battery and a clip member or pocket for releasably securing a cell phone while it charges. The charging device utilizes an inductive charger, i.e. wireless charger, for charging the cell phone that is secured thereto. Alternatively, the charging device may include one or more power plug adaptors for use in conjunction with one or more varieties of cell phones. A retractable or removable AC power plug in connection with the rechargeable battery may be connected to an AC power plug for recharging the battery inside the device. Alternatively, a solar powered recharging system may be employed for recharging the battery inside the device. The charging device further includes wireless data exchange connectivity (e.g. BLUETOOTH®) and/or audio connection wiring in communication with speakers for playing music stored on the secured cell phone. In one embodiment, the speakers are vibratory speakers (i.e. vibration transducers) for utilizing solid surfaces in contact with the speakers to amplify sound. In addition to a stuffed animal, further embodiments of the charging device may include a pillow or other cushioned object. The internal battery, speakers, power plug adaptors and/or inductive charger, audio connections and AC power plug may be removed so that the stuffed animal, or other cushioned object, may be machine laundered. The device further includes a handle or “back pack”-like strap for carrying the charging device.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view illustrating the stuffed animal cell phone charging device of the present invention;

FIG. 2 is an isolated view of the stuffed animal cell phone charging device taken from FIG. 2 illustrating the pocket, including two power plug adaptors and an audio plug for connection to a cell phone;

FIG. 3 is an isolated view of an another embodiment of the pocket, including an elastomeric transparent band for securing the upper portion of a cell phone;

FIG. 4 is a perspective view, shown in partial cross-section, illustrating the stuffed animal cell phone charging device of the present invention;

FIG. 5 is a perspective view of another embodiment of the cell phone charging device, wherein the components of the device are included in a cushioned pillow; and

FIG. 6 is a perspective view illustrating the stuffed animal cell phone charging device of the present invention.

Like reference numerals refer to like parts throughout the several views of the drawings.

### DETAILED DESCRIPTION OF THE PREFERRED EMBODIMENT

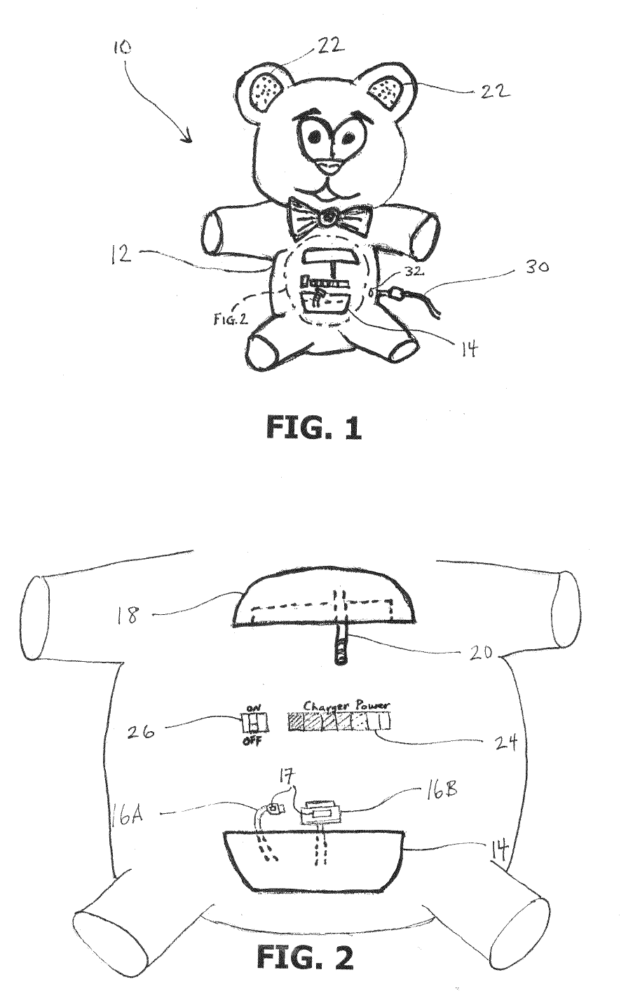

Referring to the several views of the drawings, and initially FIGS. 1 and 2, the stuffed animal cell phone charging device is shown and is generally indicated as 10. In each embodiment, the cell phone charging device 10 includes an internal rechargeable battery 50 for charging a cell phone 100 or other electronic device (e.g. portable music player) while providing a cushioned exterior for added safety of the cell phone 100 and added comfort for the user. In a preferred embodiment, the charging device 10 utilizes an inductive charger, i.e. wireless charger, for charging the cell phone 100 that is secured thereto.

The cell phone charging device 10 includes a main body member 12 having an exterior made of a soft material, and having a cushioning material, such as cotton, contained therein. Referring to FIG. 2, a securing member, such as a lower pocket 14, is provided for snuggly receiving and securing a bottom portion of a cell phone 100. The rechargeable battery 50 uses an inductive charger, i.e. wireless charger, for inductively coupling and charging the cell phone 100 secured to the device 10. Alternatively, one or more power plug adaptors 16A and 16B, such as a micro USB power adaptor, may be provided for connection with a variety of different cell phones 100 when secured in the lower pocket 14. A light source 17, such as an LED, may be included on the power plug adaptors 16A and 16B to assist the user in plugging in his or her cell phone 100 in low light level conditions. An inverted upper pocket 18 securely holds the top portion of the cell phone 100 to the device 10.

The charging device 10 further includes wireless data exchange connectivity (e.g. BLUETOOTH®) and/or an audio plug 20 in communication with speakers 22 extending from the device 10 for playing music stored on the cell phone 100. The speakers 22 may also be used in conjunction with a connected cell phone 100 during a phone call as a speakerphone. In one embodiment, the speakers 22 are vibratory speakers (i.e. vibration transducers) for utilizing solid surfaces in contact with the speakers 22 to amplify the sound emitted therefrom. A battery power indicator 24 is provided for indicating the remaining battery power in the internal rechargeable battery 50. An ON/OFF switch 26 may be included for turning the device 10 on and off.

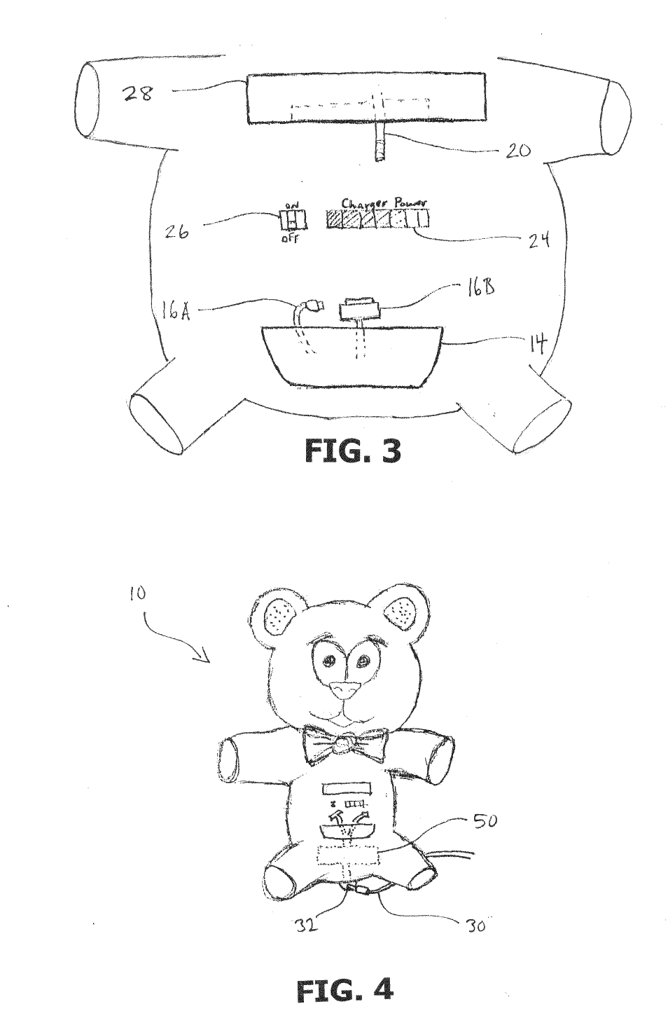

FIG. 3 illustrates another embodiment of the mechanism for securing the cell phone 100 to the charging device 10. In this instance, an elastomeric transparent band 28 is used to secure the upper portion of the cell phone rather than an inverted upper pocket 18. The transparent band 28 securely holds the upper portion of the cell phone 100 in place while also allowing a user to see any portion of the cell phone's screen that is covered by the band 28.

Referring to FIG. 4, the internal rechargeable battery 50 is in connection with an AC power adaptor 30, which is used to charge the internal battery 50. The AC power adaptor 30 may be retractable and moveable between a retracted position, wherein a portion of the adaptor is within the body of the device 10, and an extended position, wherein the adaptor is extended outward of the device 10. In another embodiment, the AC power adaptor 30 may be removable, as shown in FIG. 1, wherein a plug 32 receives the adaptor 30 for connecting the rechargeable battery 50 to the adaptor 30. Alternatively, a solar powered recharging system may be employed for recharging the battery 50 inside the device 10.

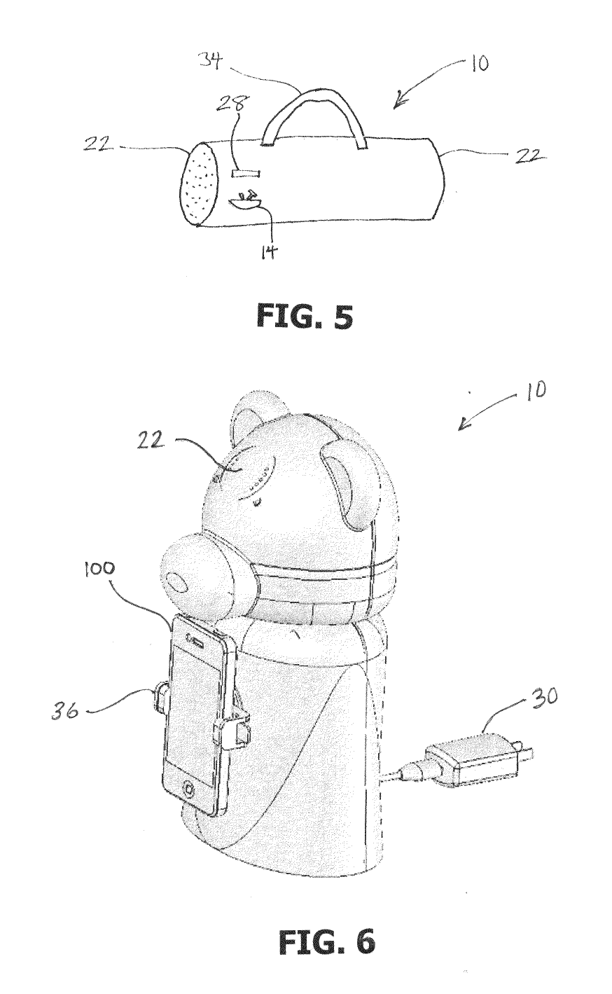

The charging device 10 may be in the form of other cushioned objects, such as a pillow, as illustrated in FIG. 5. Additionally, the device 10 may include straps 34, similar to those found on a handbag or a backpack, to assist a user in transporting the device 10.

Referring to FIG. 6, an alternative embodiment of the cell phone charging device 10 is shown, wherein the cell phone 100 is securable to the main body 12 using a clip member 36 that may be expanded and retracted for engaging opposite sides of a cell phone 100, thereby making clip member 36 useful for securing various sizes of cell phones 100 and other electronic devices.

The internal battery 50, speakers 22, power plug adaptors 16A and 16B, audio plug 20 and AC power plug 30 may be removed so that the stuffed animal, or other cushioned object, may be machine washed.

While the device 10 has been shown and described for use in combination with a cell phone 100, the device 10 may also be used in combination with other portable electronic devices, such as portable music players and computer tablets. Moreover, it is recognized that technological advances are expected and the device 100 is considered adaptable to accommodate such advances.

While the present invention has been shown and described in accordance with a preferred and practical embodiment thereof, it is recognized that departures from the instant disclosure are fully contemplated within the spirit and scope of the invention.

What is claimed is:

1. A device for charging at least one portable electronic device, and said device comprising:
a main body having a cushioned exterior surface and at least one accessible cavity;
a securing member on the cushioned exterior surface of said main body being structured and disposed for releasably securing the at least one portable electronic device to said main body;
a rechargeable battery sized for receipt in the at least one accessible cavity of said cushioned main body, and said rechargeable battery being in connection with an AC power adaptor for recharging said rechargeable battery, and said rechargeable battery being removable from the at least one accessible cavity;
said rechargeable battery being structured and disposed for charging the at least one portable electronic device; and
at least one speaker on said main body structured and disposed for producing sound in response to the electrical signal input received from the at least one portable electronic device.

2. The device as recited in claim 1 wherein said main body is in the shape of a stuffed animal.

3. The device as recited in claim 1 wherein said securing member comprises an elastomeric pocket for releasably securing a bottom portion of said at least one portable electronic device.

4. The device as recited in claim 3 further comprising an inverted pocket for releasably securing a top portion of said at least one portable electronic device.

5. The device as recited in claim 3 further comprising an elastomeric transparent band for releasably securing a top portion of said at least one portable electronic device.

6. The device as recited in claim 1 wherein said securing member is an expandable and retractable clip member structured and disposed for engaging opposite sides of the at least one portable electronic device and said expandable and retractable clip member being adapted for securing various sizes of portable electronic devices.

7. The device as recited in claim 1 wherein said rechargeable battery is in connection with at least one power plug adaptor sized and configured for attachment to the at least one portable electronic device for charging the at least one portable electronic device.

8. The device as recited in claim 1 wherein said rechargeable battery is structured and disposed for wirelessly coupling with the at least one portable electronic device for inductively charging the at least one portable electronic device.

9. The device as recited in claim 1 further comprising wireless data exchange connectivity for wirelessly pairing the at least one portable electronic device with said at least one speaker.

10. The device as recited in claim 1 wherein said at least one speaker is a vibratory speaker.

11. The device as recited in claim 1 wherein said main body is machine washable.

12. The device as recited in claim 1 further comprising at least one strap affixed to said main body, and said at least one strap being sized and configured for grasping by a user for transporting said device.
